(19) United States
(12) Patent Application Publication
(10) Pub. No.: US 2013/0325668 A1
(43) Pub. Date: Dec. 5, 2013

(54) INTERNET PROCUREMENT WITH PROCUREMENT THRESHOLDS AND NOTIFICATIONS WITH RESPECT THERETO

(71) Applicant: CONSUMERS INTERSTATE CORPORATION, (US)

(72) Inventor: Kenneth Alan Fischburg, Norwich, CT (US)

(73) Assignee: CONSUMERS INTERSTATE CORPORATION, Norwich, CT (US)

(21) Appl. No.: 13/793,905

(22) Filed: Mar. 11, 2013

Related U.S. Application Data
(60) Provisional application No. 61/609,017, filed on Mar. 9, 2012.
(60) Provisional application No. 61/724,040, filed on Nov. 8, 2012.

(51) Int. Cl. G06Q 30/06

(52) U.S. Cl. CPC G06Q 30/0635
USPC 705/26.81

(57) ABSTRACT

In a method for procuring goods and/or services, needs and procurement habits of a customer are determined. The needs include one or more budgetary spending thresholds, goals and/or constraints. A web site is hosted and operative with a program and a database. Data and information indicative of the customer's needs and habits is input into the database. A plurality of GUIs is presented, the GUIs being customizable by the customer. The GUIs include an order entry/shopping list GUI that the customer uses to place an order. As the order is processed costs of the order are accumulated at a customer defined level and compared to predetermined budgetary spending thresholds, goals and/or constraints. When the accumulated cost approaches, meets or exceeds one or more of the budgetary spending thresholds, goals and/or constraints, a notification message is generated to at least one person of interest.

### CROSS REFERENCE TO RELATED APPLICATIONS

This patent application claims benefit under 35 U.S.C. §119(e) of copending, U.S. Provisional Patent Application Ser. Nos. 61/609,017, filed Mar. 9, 2012, and 61/724,040, filed Nov. 8, 2012, the disclosures of which are incorporated by reference herein in their entireties. This patent application is also related to commonly owned, U.S. patent application Ser. No. 11/376,027, filed on Mar. 14, 2006, now pending.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### TECHNICAL FIELD

The present invention relates generally to a web-based procurement method and monitoring thereof. More particularly, the present invention relates to a method of procuring goods and/or services via a global communications network such as the Internet in which procurement transactions are monitored, costs accumulated and compared to predefined procurement (e.g., budgetary spending) thresholds, goals and/or constraints, and notifications based on the comparisons are communicated to persons of interest to facilitate the control of the procurement of the goods and/or services. In one embodiment, the procurement transactions (e.g., orders for goods and/or services) are automatically reviewed and at least one of approved, denied or placed on hold at a point of ordering based on the comparisons of accumulated costs to budgetary spending thresholds, goals and/or constraints.

### BACKGROUND OF THE INVENTION

Corporations and other organizations generally employ purchasing agents and/or assign the responsibility to various persons acting as buyers in the organization to procure supplies (e.g., goods) and/or services such as, for example, paper products, office supplies, janitorial products and services, and the like, whether consumed by the organization or used for resale to the public or other companies. The goods and/or services may be procured from one or several different vendors and by different buyers in the organization. For example, an organization having facilities in different locations, or multiple departments or groups within one facility, may have a purchasing agent/buyer in each locale, department or group buying goods and/or services from the same or different vendors and possibly at different prices. When the same goods and/or services are purchased by different persons from different sources, a lack of effective communication can result in the payment of disparate amounts for the same good and/or service as well as the overstocking or understocking of certain goods and/or services at a person or group of persons level, a goods/service or group of goods/services level, a facility or group of facilities level, or an organization or group of organizations level. Furthermore, volume discounts may be lost if the persons making the purchases do not realize that different persons are each purchasing the same goods and/or services. Moreover, actual procurement (e.g., budgetary spending) at a person level or a group of persons level, a goods/service level or group of goods/services level, a facility level or a group of facilities level, or an organization level or a group of organizations level may exceed predetermined budgetary spending thresholds, goals and/or constraints.

In general, to purchase or order goods and/or services, the person or persons tasked with purchasing activities manually or electronically utilizes an order form or other means of requesting goods and/or services such as, for example, a printed form or an online form or screen. Typically, such order forms or screens include a predetermined list of goods and/or services determined to satisfy the procurement needs of the person and the organization (e.g., group, department or other portion thereof). In some systems ordering includes an open opportunity to procure goods and/or services by, for example, browsing an online catalog or reviewing a printed catalog. The manual use of paper forms can be time consuming and subject to loss, misfiling, or lag times that causes undesirable delays in the delivery of goods and/or services. Typical form-based systems lack mechanisms to account for a budget (e.g., funds) available or planned budgetary spending thresholds, goals and/or constraints (e.g., preset spending budgets, aims for controlled increases or decreases, or express limits on spending) to procure the goods and/or services. The aforementioned, commonly owned, U.S. patent application Ser. No. 11/376,027, teaches various improvements aimed at eliminating perceived limitations in prior art procurement systems and the use of electronic forms therein.

Based on the foregoing, it is the general object of this invention to provide a electronic method of procuring goods and/or services that improves upon, or overcomes the problems and drawbacks of, prior art systems.

### SUMMARY OF THE INVENTION

Based on the foregoing, the present invention provides an electronic method of procuring goods and/or services that is capable of being customized to eliminate, minimize, or at least accommodate the inefficiencies inherent in the prior art methods of electronically procuring goods and/or services. The present invention also provides an effective means of monitoring and controlling the cost of goods and/or services ordered within an organization by communicating at a point of ordering notification messages to persons of interest as one or more predetermined budgetary spending thresholds, goals and/or constraints are approached, met or exceeded. The present invention further provides features for automatically reviewing procurement transactions (e.g., orders for goods and/or services) and at least one of approving, denying or placing transactions on hold at the point of ordering based on comparisons of accumulated costs of transactions to the one or more predetermined budgetary spending thresholds, goals and/or constraints.

In one embodiment, the present invention resides in a system and method for procuring goods and/or services. The method is executable on a processor based system having a processor and memory with an executable program stored therein. The method includes determining a specific procurement process of a user and data related thereto. The process data includes one or more budgetary spending thresholds, goals and/or constraints for procurement of the goods and/or services. The method includes hosting, by the processor, a website operative with the program and a content database, and receiving the data indicative of the user's procurement process for the goods and/or services and storing the received data in the content database. A value representing a budgetary spending set point is determined based on the one or more budgetary spending thresholds, goals and/or constraints. The method also includes presenting, at the website, a plurality of graphical user interfaces (GUIs) using the program and the data stored in the content database. The plurality of GUIs include fields for selecting the goods and/or services to create one or more orders. The method includes processing the one or more orders within the user's procurement transactions. The orders are processed by accumulating procurement data from the one or more orders. The procurement data includes cost associated with the goods and/or services within the order transactions. The orders are also processed by comparing the value representing the budgetary spending set point to a value representing the cost within the accumulated procurement data, and when the value representing the cost within the accumulated procurement data at least one of approaches, meets and surpasses the value representing the budgetary spending set point, generating at least one notification message. After the order is processed, the method includes shipping the goods and/or providing the services to the customer/user.

In one embodiment, the step of determining the user's specific procurement process includes inventorying a facility of the user, auditing the user's procurement records, and querying the user's personnel involved with the procurement process and collecting the data related thereto. In one embodiment, the budgetary spending thresholds, goals and/or constraints are determined for a period at one of a user level, a group of users level, a goods/service level, a group of goods/services level, a facility level, a group of facilities level, or an organization level or group of organizations level. In one embodiment, the period is a period of time including hourly, daily, weekly, monthly, quarterly, yearly, or a portion thereof.

In one embodiment, the stored data indicative of the user's procurement process for the goods and/or services defines a procurement knowledge base for the user, and the method further includes continually updating the procurement knowledge base for the user with the accumulated procurement data for the user. In this embodiment, the value representing the budgetary spending set point is updated based on the updated procurement knowledge base. In one embodiment, the method further includes monitoring performance of the user to the one or more budgetary spending thresholds, goals and/or constraints. In this embodiment, the value representing the budgetary spending set point is updated based on the monitored performance of the user relative to the one or more budgetary spending thresholds, goals and/or constraints.

In one embodiment, the generated notification message includes one of a visual, audio or written notification message. In one embodiment, the notification message includes one of a message that is exhibited on at least one of the plurality of GUIs. In one embodiment, the notification message includes sending at least one message to at least one user's contact information. In these embodiments, the user defines one or more persons of interest to receive the generated notification message. In one embodiment, the order is processed and the notification message is generated at one of a point of entering the order on one of the plurality of GUIs, and at a scheduled interval after the order is entered on one of the plurality of GUIs.

In one embodiment, the step of presenting the plurality of GUIs includes exhibiting on the plurality of GUIs the value representing the budgetary spending set point, the value representing the cost within the accumulated procurement data, and a value representing cost available for additional order transactions. In one embodiment, the value representing cost available for additional order transactions is derived by subtracting the value representing the cost within the accumulated procurement data from the value representing the budgetary spending set point. In one embodiment, the generated notification message varies in at least one of color, size, intensity, and duration as the value representing the cost within the accumulated procurement data approaches, meets and surpasses the value representing the budgetary spending set point.

In one embodiment, the method further includes processing the one or more orders at a point of order entry, and automatically determining a status of the order based on the comparison of the value representing the cost within the accumulated procurement data and the value representing the budgetary spending set point. In one embodiment, the status of the order includes at least one of approving the order, denying the order, and placing the order on hold. In one embodiment, the status of the order is at least one of denied and placed on hold when at least one of the cost of the order exceeds a predetermined spending limit, would result in an accumulated cost that is within a predetermined percentage from the budgetary spending set point, is placed after a predetermined date, and would result in delivery of goods and/or services after a predetermined date. In one embodiment, the status of the order is approved when the cost of the order is less than a predetermined minimum quantity or a predetermined minimum cost.

### BRIEF DESCRIPTION OF THE DRAWINGS

FIG. 1 is a schematic block diagram of an exemplary system for procuring goods and/or services utilizing a content database that can be accessed through a web site address of the Internet, in accordance with one embodiment of the present invention.

FIG. 2 is a schematic block diagram of a procurement process in accordance with one embodiment of the present invention.

FIG. 3 is a schematic block diagram of a procurement order entry step of the procurement process of FIG. 2, in accordance with one embodiment of the invention.

FIGS. 4A-4D depict exemplary graphical user interfaces (GUIs) presented as web pages of the procurement process of FIG. 2, in accordance with one embodiment of the invention.

FIG. 5A depicts one embodiment of a notification message provided to a user of the web pages of FIGS. 4A-4D, in accordance with the invention.

FIG. 5B depicts one embodiment of a GUI presented as a web page for setting one or more thresholds for generating notification messages and identifying one or more persons of interest receiving such messages, in accordance with the invention.

FIGS. 6A and 6B depict other embodiments of the notification message provided to the user of the web pages of FIGS. 4A-4D, in accordance with the invention.

FIG. 7 depicts an exemplary GUI for assigning and/or updating budgetary spending thresholds, goals and/or constraints, in accordance with one embodiment of the invention.

FIG. 8 depicts an exemplary performance report format, in accordance with one embodiment of the invention.

### DETAILED DESCRIPTION OF THE PREFERRED EMBODIMENTS

The present invention is directed to web-based systems and methods of procuring goods and/or services utilizing one or more customizable graphical user interfaces (GUIs) presenting procurement data and information. The GUIs may include, for example, an account or order entry GUI providing features and functions for account or order entry, an account or order update GUI providing features and functions for reviewing and adding, changing or deleting account or order data and information, and an account or order approval GUI providing features and functions for reviewing and approving, denying, delaying or suspending account or order data and information. The customizable GUIs within the web-based procurement systems and methods provide what is referred to herein as a SUPERSUPPLIES™ system. The SuperSupplies system includes a budgetary spending notification function and an automatic review and approval, denial or hold function deployed within a virtual budgetary software module or agent, referred to herein as a SILENT SUPERVISOR module. SuperSupplies and Silent Supervisor are trademarks of Consumers Interstate Corporation, Norwich, Conn. USA. The SuperSupplies system and the Silent Supervisor module provide procurement (e.g., spending) information and data (e.g., in real time and/or at scheduled intervals) at a user level, a group of users level, a goods/service level, a group of goods/services level, a facility level, a group of facilities level, an organization level and/or a group of organizations level. The procurement data and information is monitored, costs accumulated and compared to predetermined budgetary spending thresholds, goals and/or constraints, and as the predetermined budgetary spending thresholds, goals and/or constraints are at least one of approached, met or surpassed with continuing procurement activities, notifications are generated by the Silent Supervisor module and provided to one or more persons of interest. In one embodiment, the procurement data and information is automatically reviewed at the point of ordering (e.g., as orders for goods and/or services are entered) and are at least one of approved, denied or placed on hold based on comparisons of accumulated costs of the procurement transactions to one or more predetermined budgetary spending thresholds, goals and/or constraints.

As used herein, the term “threshold” refers to a starting point or value for budgetary spending, the term “goal” refers to a targeted or aimed value (e.g., being an increase or decrease of a threshold value) for budgetary spending, and the term “constraint” refers to an end point or maximum value for budgetary spending. In one embodiment, a threshold value may be set based on a past spending value. For example, a threshold may be set at a value below, at or above a past actual spending value of a predetermined time period (e.g., a week, month, quarter, year or the like). In one embodiment, a spending threshold may represent a value at which a person, department, facility, or organization plans to be a minimum value of procurement during a next time period. With this example, a spending goal may represent a percent increase or decrease in value based on the spending threshold, and a spending constraint may represent a maximum value for procurement based on the spending threshold and/or spending goal. Accordingly, the Silent Supervisor module monitors predetermined budgetary spending thresholds, goals and/or constraints, and as one or more of the predetermined budgetary spending thresholds, goals and/or constraints are at least one of approached, met or surpassed with continuing procurement activities, generates notifications to one or more persons of interest.

In one embodiment, the Silent Supervisor module implements a multi-level or multi-tiered notification system to alert the one or more persons of interest (e.g., users) of the web-based systems and methods as one or more of the predetermined budgetary spending thresholds, goals and/or constraints are approached, met or surpassed by continuing procurement activities. The system generated notifications include, for example, visual, audio or written notification provided in a message on the GUIs such as, for example, a colored and/or blinking icon, a banner message, a broadcast message, an audio tone or alert message, or the like, provided to or on a display device of a computing device operated by the user, a message sent in accordance with a user's contact information such as, for example, an electronic mail or text message sent to a predetermined address of the user, and the like. In one embodiment, the system generated notifications may vary in color, size, intensity, duration or the like, as cost accumulations vary in proximity to the one or more predetermined budgetary spending thresholds, goals and/or constraints.

For example, when a selected cost accumulation data value with one of the aforementioned levels approaches a first of the one or more predetermined budgetary spending thresholds, goals and/or constraints, a notification message is generated and appears in a first colored font (e.g., the notification message appears in a yellow font color). When the selected cost accumulation data value continues to grow with continued procurement activity, and meets a second one of the one or more predetermined budgetary spending thresholds, goals and/or constraints, the notification message changes from the first colored font to a second colored font or appears as a blinking font (e.g., the notification message changes from the yellow colored font to an orange colored font). When the selected cost accumulation data value further grows with continuing procurement and exceeds or surpasses the predetermined budgetary spending thresholds, goals and/or constraints, the notification message appears as a third colored font or appears as a rapidly blinking font (e.g., the notification changes from the orange font color to a red font color). It should be appreciated that it is within the scope of the present invention for the system generated notification messages and changes thereto to be considered broadly. As such, some exemplary system generated notification messages formats and styles are described in further details below, but those skilled in the art appreciate that the notification messages may take any number of formats, styles and the like as are known or would be considered convenient to those skilled in the art to convey a change in status to users of the systems and methods described herein.

As described herein customizable GUIs can be accessed via an internet web site address (e.g., URL) hosted by a server computer to enter, review, update, delete approve, deny, or suspend procurement transactions, and data and information pertaining thereto, to monitor and control the procurement of goods and/or services. The terms “user” and “person of interest” as used herein are intended to broadly embody one or more persons acting individually or acting for a group or department within a company or other organization or group of companies or organizations that carries out activities of a purchasing agent, buyer, cost analyst, person whose duties include the procurement of goods and/or services for him/herself, a group or department within a company, a company, group of companies, or another person, group, department, company or group of companies, as well as a supervisor, manager, executive or other person who oversees the procurement of goods and/or services. Each user or person of interest can access account and order data and information presented on one or more GUIs customized to the user's procurement needs. The GUIs can be customized for the user and, to a certain extent, by the user. As described in the aforementioned commonly owned, US patent documents, data and information indicative of the procurement process and user's procurement needs can be determined by an inventory of one or more of the user's facilities, by an audit of the user's procurement records, and/or by querying personnel involved with the procurement needs of a user. The term “goods” as used in this disclosure includes, but is not limited to, raw materials, purchase parts, processed materials (e.g., machined or plated parts), assemblies of parts and/or raw materials, and maintenance, repair, and operational (MRO) items such as packaging, janitorial, office supplies, food service, safety, and maintenance items. The term “services” should be broadly construed to include advertisements, warranties, maintenance contracts and the like. Once the procurement needs are determined, a flow chart of the steps involved in the user's procurement process can be developed.

Data indicative of the user's specific procurement process is then input into a content database establishing a procurement knowledge base for the user that is maintained by the SuperSupplies system. It should be appreciated that, in accordance with the present invention, the procurement knowledge base may be continuously monitored and updated by the user and/or system administrator such that the procurement knowledge base and functionality based thereon (e.g., the Silent Supervisor module as implemented within the SuperSupplies system) reflects, provides visibility to current and past performance, and implements the user ever changing needs, requirements and goals for procurement spending. In one embodiment, the data indicative of the user's specific procurement process includes at least one of predetermined budgetary spending thresholds, goals and/or constraints established for a predetermined period at one of a user level, a group of users level, a goods/service level, a group of goods/services level, a facility level, a group of facilities level, or an organization level or group of organizations level, and an accumulation of procurement (e.g., spending) data from purchases and/or orders placed during a predetermined time period such as, for example, in real-time, daily, weekly, monthly, quarterly, yearly, or the like. In one embodiment, the predetermined budgetary spending thresholds, goals and/or constraints may be based upon previously accumulated procurement data for a given time period such as, for example, actual procurement data from a previous hour, day, week, month, quarter, year or the like or portions thereof. With the actual procurement data the Silent Supervisor Module implements a user's efforts to decrease, maintain, increase or suspend future procurement activities based on the previously accumulated actual procurement data. In real time (e.g., at a point of ordering) and/or at scheduled intervals (e.g., nightly), the virtual budgetary software agent (e.g., the Silent Supervisor module) retrieves the data and information from the content database and compares the thresholds, goals and/or constraints to the accumulation data of actual purchase and/or order data and generates a notification, warning or like message, as the accumulation data at least one of approaches (e.g., within a predetermined percentage), meets or surpasses at least one of the predetermined budgetary spending thresholds, goals and/or constraints. The generated notification, warning and like message and any other data indicative of the user's specific procurement process are displayed on the one or more customized GUIs accessible via the web site. For example, the system generated notification messages may include, for example, visual, audio or written notification messages provided in a message on the GUI (e.g., colored or blinking icon, banner message, broadcast message, or the like), a message sent per a user's contact information (e.g., an email or text message sent to a predetermined address), and the like.

The retrieved data can be further manipulated within the SuperSupplies procurement system to customize the GUIs to the user's specific needs. Links can also be provided to other web pages. Such links may utilize the content database to present various other product specifications and information for the benefit of the user, including, but not limited to, such things as detailed product comparisons. Furthermore, new product searches and current procurement data from the customized and/or predetermined order form and/or list of goods and/or services to be purchased can be accessed from the same web site.

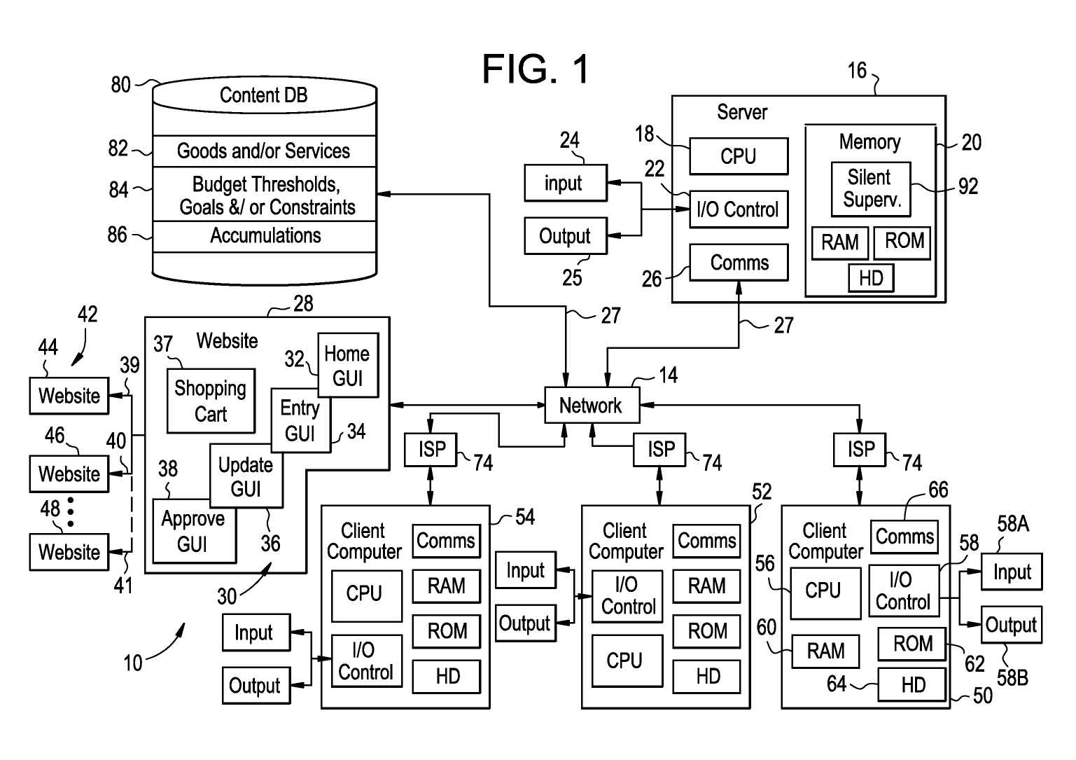

FIG. 1 illustrates an exemplary embodiment of the SuperSupplies procurement system, shown generally at 10, configured and operating to implement instructions and algorithms for procuring goods and/or services as described herein. The SuperSupplies procurement system 10 includes at least one of a budgetary spending notification function and an automatic review and at least one of approval, denial and/or hold order function deployed as a virtual budgetary software module or agent 92, e.g., the Silent Supervisor module 92, operating therein. The procurement system 10 also includes a server computer or server 16 having a server central processing unit (CPU) 18, server memory 20 that can include random access memory (RAM), read only memory (ROM), a hard drive (HD), and the like, input/output controller (I/O CNTRL) 22 operatively coupled to input 24 and output 25 devices such as a keyboard, mouse, light pen or other pointing device, a document, card or other medium reader or scanner, a printer, a monitor or other display device for facilitating input to and output from the system 10 of data and information, and an electronic communication apparatus (COMMS) 26 for communicating, as indicated by reference numeral 27, with a computerized communication network 14 such as, for example, the Internet, an intranet, an extranet, or like distributed communication platform connecting computing devices over wired and/or wireless connections. The server CPU 18 executes computer-implemented algorithms and instructions residing in memory 20 to implement the SuperSupplies procurement system 10, the budgetary notification function, the automatic review and approval, denial and/or hold order function, and the Silent Supervisor module 92, as described herein.

The server 16 accesses a content database 80 directly or through the network 14. The content database 80 receives and stores data and information 82 indicative of goods and/or services available for display to and purchase by the users, data and information 84 indicative of budgetary spending thresholds, goals, constraints and/or the like, data and information 86 indicative of current and past cost accumulations or tallies of orders/purchases of the goods and/or services and the like within a predetermined and/or user defined time period or a plurality of time periods. In one embodiment, the data and information 84 indicative of the budgetary spending thresholds, goals and/or constraints as well as the data and information 86 indicative of cost accumulations are set and monitored for a predetermined time period at a level of at least one of a user level, a group of users level, a goods/service level, a group of goods/services level, a facility level, a group of facilities level, an organization level or a group of organizations level. The user and/or system administrator may customize the levels to meet and provide visibility to one or more business needs or requirements. As described below, in one embodiment, the budgetary spending thresholds, goals and/or constraints may be based upon past procurement activities of, for example, a user, group, department or company (e.g., increase, decrease, or maintain past levels as defined by the user) or, for a new account or user, recommended budgetary spending thresholds, goals and/or constraints set by an administer based upon industry standards, “like” users where like or similar user are comparable by, for example, a number of employees, trade channel, gross or net sales, etc.

As shown in FIG. 1, the server 16 hosts a user interface such as a web site 28 having a plurality of GUIs 30 including, for example, a home page GUI 32, an account or order entry GUI 34 providing features and functions for account or order entry, an account or order update GUI 36 providing features and functions for reviewing and adding, changing or deleting account or order data and information, an account or order approval GUI 38 providing features and functions for reviewing and approving, denying, delaying or suspending account or order data and information, and a shopping cart GUI 37 for receiving the order data and information for further processing. The web site 28 may be requested by users of the procurement system 10 through designation of a Uniform Resource Locator (URL) identifying the web site 28 (e.g., www.supersupplies.com) and web page GUIs 30 (e.g., GUIs 32, 34, 36, 37 and 38), and providing access to the server 16 from other computing devices on the network 14. In one embodiment, access to the web site 28 and web page GUIs 32, 34, 36, 37 and 38, and/or selected portions thereof, and/or to selected services and functionality provided by the SuperSupplies procurement system 10, is restricted to registered (e.g., “member”) buyers and other users, as is described below, executing programs such as, for example, web browser software to request, receive and process the web site 28 and web page GUIs 32, 34, 36, 37 and 38. The web page GUIs 30 are generally written in a language that permits a graphical presentation of data and information (text, images, audio, video, and the like) to persons operating a computing device. Languages include for example, the Hyper-Text Markup Language (HTML), Extensible Markup Language (XML) or another Standard Generalized Markup Language (SGML), as are generally known in the art.

As will be described in greater detail hereinafter, the GUIs 30 can be customized to a user's specific procurement needs, process and/or budgetary spending thresholds, goals and/or constraints placed thereon. As noted above, this data and information is stored in the content database 80, and may be obtained by, for example, inventorying a user's facility, auditing procurement records, querying personnel involved with procurement or tracking and analyzing a user's past procurement process, habits, or any combination thereof. To initiate an order, the custom order entry GUI 34 can display a variety of goods and/or services relevant to the user's specific needs or that are related to the user's business. The user can fill in the order entry GUI 34 and enter an order for all goods and/or services listed as selections on the order entry GUI 34 in the procurement system 10. Once entered, the order data and information is saved to the content data base 80, accumulations (e.g., totals of the type and quantities of goods and/or services ordered and costs associated therewith) are updated, analyzed, and compared to the predetermined budgetary spending thresholds, goals and/or constraints by the Silent Supervisor Module 92. As can be appreciated, the entry, update, deletion, review and approval, denial or suspension of procurement data may trigger a real time response and/or a response at scheduled intervals (e.g., one or more times during a day, a night, a week, a month or portions thereof) by the Silent Supervisor Module 92 to notifying the users of a current status, and/or approaching or exceeded budgetary spending thresholds, goals and/or constraints. The notification messages are displayed on one or more of the customizable account/order entry GUI 34, account/order update GUI 36, the account/order approval GUI 38, as well as any other GUIs 30 (e.g., an order or account inquiry), as is described herein.

The customizable GUIs 30, which in one embodiment are in the form of web pages, present the user access to the content database 80 to enter, review, update, delete approve, deny, or suspend procurement transactions, and data and information pertaining thereto, to monitor and control the procurement of goods and/or services. The GUIs 30 may also provide access to various customized venues relevant to the particular user. By way of example, one or more of the web site 28 and/or the GUIs 30 (e.g., web pages 32, 34, 36, 37 and 38) provides links 39, 40, 41 to other web sites 42 such as a web site 44 that presents product information and specifications of interest to a user, web site 46 can present information relevant to new products searches, and web site 48 can present current user procurement data.

As shown in FIG. 1, the procurement system 10 includes a plurality of user or client computers 50, 52 and 54 operable by users to retrieve the information from the web site 28. Each of the user computers 50, 52 and 54 includes a user computer central processing unit (CPU) 56, an input-output controller (I/O CNTRL) 58 operatively coupled to input 58A and output 58B devices such as a keyboard, mouse, light pen or other pointing device, a document, card or other medium reader or scanner, a printer, a monitor or other display device for facilitating input to and output from the system 10 of data and information, user computer memory that can include RAM 60, ROM 62, and a hard drive 64, and an electronic communication apparatus (COMMS) 66 for communicating with server computer 16 over the network 14. The COMMS 66 can include a modem or a connection to a local area network (LAN), either of which can access an internet service provider (ISP) 74 through a wired or wireless communication line such as a telephone network, television cable lines, satellite links, DSL lines, or the like. The user computers 50, 52 and 54 may be an IBM-type or Apple Personal Computer (or compatible analogs thereof) suitable for running a browser program for accessing and communicating over the network 14 including, for example, a workstation, laptop, notebook, tablet or other portable computing devices such as an ipad, smart phone, or the like.

As noted above, the computers 16, 50, 52, and 54 can include the electronic communication apparatus 26 and 66, respectively. The term “electronic communication apparatus,” as used herein, refers to an apparatus that facilitates electronic communication with another computer using a selected interconnection mechanism, such as a telephone network, a LAN, an intranet, or the Internet, and a selected communication protocol, such as V.90 or V.32, or in the case of the Internet, TCP/IP. The electronic communication apparatus can also include wireless or IR communication mechanisms. Electronic communication apparatus also includes circuitry that provides parallel, serial, Scsi, USB, Firewire, and other such ports known in the art, and protocols such as, but not limited to, Appletalk. The foregoing are merely examples of electronic communication apparatus, and the present invention is not limited to these examples.

As described herein, the content database 80 is accessible by or is resident on the server 16 and aids in the provision of data and information 82 indicative of raw material, parts, supplies, and services available for display to and purchase by the users, data and information 84 indicative of budgetary spending thresholds, goals, constraints or the like, data and information 86 indicative of current and/or past cost accumulations or tallies of orders/purchases of the goods and/or services (including types, quantities and costs thereof) and the like within a predetermined and/or user defined time period. In one embodiment, the data and information is presented on the form of one or more customizable GUIs 30 to the user computers 50, 52, and 54 for exhibition on the output device 58B such as a display device. As is generally known, the content database 80 can include data and information stored locally, that is, on the memory 20 of the server 16, and can also include links or pointers to data and information available elsewhere, such as on other sites (e.g., web sites 44, 46, 48, or the like) on the network 14.

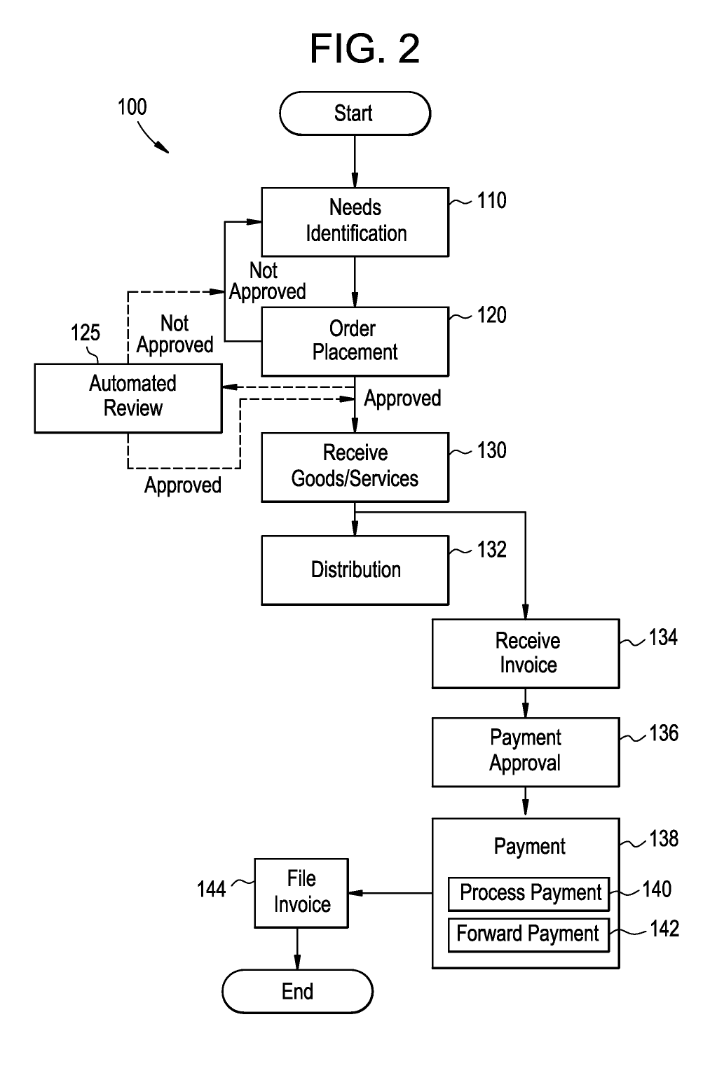

Referring to FIG. 2, an exemplary procurement process, utilizing the SuperSupplies procurement system 10 including the Silent Supervisor module 92 for procuring goods and/or services, is shown generally at 100. In the procurement process 100, the flow (e.g., ordering and usage) of goods and/or services to the user is analyzed in an identification step 110 in which the user's needs for the goods and/or services are identified. As described in the aforementioned, commonly owned, U.S. patent application Ser. No. 11/376,027, one exemplary identification step 110 includes a determination of a user's specific procurement process by at least one of three separate steps including, for example, an inventory step where parameters that may be defined including, but are not limited to, a count of a specific number of goods/services currently on hand, an audit step where the user's procurement records may reveal information pertaining to frequency of use for specific goods/services, unit costs, supplier information, delivery information, and shipping information, and a query step where personnel involved with the procuring of goods are queried to track the actual workflow involved in the purchase/order of goods and/or services. The query step can include online questionnaires, interview with buyers or others involved in the procurement process, or the “filling in” of an order form or order entry screen and the accumulation of past purchase data and information. As can be appreciated, portions of the identification step 110 may be completed in advance of an individual order or request for an order of goods and/or services. The information determined in the identification step 110 may be entered into the content database 80 to establish and maintain the aforementioned procurement knowledge base for the client.

The web site 28, where the customizable electronic GUIs 30 are accessible, is invoked in an order placement step 120. At the order placement step 120 the account/order entry GUI 34 is presented to the user. An order is entered by “filling out” (e.g., completing fields on) the account/order entry GUI 34. As described in detail below, order placement triggers monitoring by the SuperSupplies procurement system 10 and the Silent Supervisor module 92 and, as necessary, users are notified by the Silent Supervisor module 92 of various procurement performance characteristics with respect to budgetary spending threshold, goals and/or constraints. Once an order is entered, which may or may not be followed by one or more reviews of, updates to, and approvals of the initial and subsequent orders performed via the account/order update GUI 36 and account/order approval GUI 38, the ordered items (e.g., goods and/or services) are shipped by a supplier and received in a receiving step 130. Once received, the goods are distributed, if needed, to their final location at one or more a user's departments, facilities or organizations in a distribution step 132. Upon placing an order, or subsequent to, or simultaneously with shipping, an invoice is generated by the supplier and then received in an invoice receiving step 134 by the user. Once received, the user approves the invoice for payment in an approval step 136, and payment is made in a payment step 138. In the payment step 138, a payment instrument is processed in a processing step 140 and forwarded to the supplier in a forwarding step 142. In the forwarding step, a check (or other form of payment) may be attached to a copy of the invoice and mailed (or otherwise forwarded) to the supplier, a credit card number may be given, or funds may be transmitted electronically to the supplier. Finally, the invoice package containing receipts and copies of the payment form as well as any other pertinent documents is filed in a filing step 144.

It should be appreciated that activities during one or more of the aforementioned order entry, review, update, approval, distribution, shipping, receiving, invoicing and payment steps may result in changes in the order status that may trigger, as requested by users during their customization of the system 10, notification by the Silent Supervisor module 92 to persons of interest. For example, order statuses of “pending”, “in process”, “on hold”, and the like may be utilized to inform users and suppliers of various statuses of an order. It should be appreciated that the change of order status may also invoke further action. For example, when a maximum number of goods are received by a company, a “hold” of all future orders of the goods by the company may be broadcast in a message by the Silent Supervisor module 92 to prohibit additional orders of the goods. In one embodiment, the broadcast message may take the form of a bulletin board message displayed on one or more of the customizable GUIs 30 of the SuperSupplies procurement system 10, e.g., the web site 28 (e.g., www.supersupplies.com).

In one embodiment, the Silent Supervisor module 92 includes an automated review and approval, denial or suspension process 125. In the automated review and approval/denial/suspension process 125, which may be implemented as an option in one or more user installations of the SuperSupplies procurement system 10, the Silent Supervisor module 92 applies one or more user configurable criterion to “prequalify” an order. For example, an order may be automatically flagged for denial or suspension if the cost of the order exceeds a predetermined spending limit, would result in an accumulated cost that is within a predetermined percentage from a predetermined budgetary spending threshold, goal and/or constraint, is placed after a predetermined date, would result in delivery of goods and/or services after a predetermined date, and like criteria. Similarly, an order may be automatically flagged for approval if the cost of the order is less than a predetermined minimum quantity or cost. As can be appreciated, the criterion for such automatic approvals, denials or suspensions is fully configurable by a user and/or system administrator.

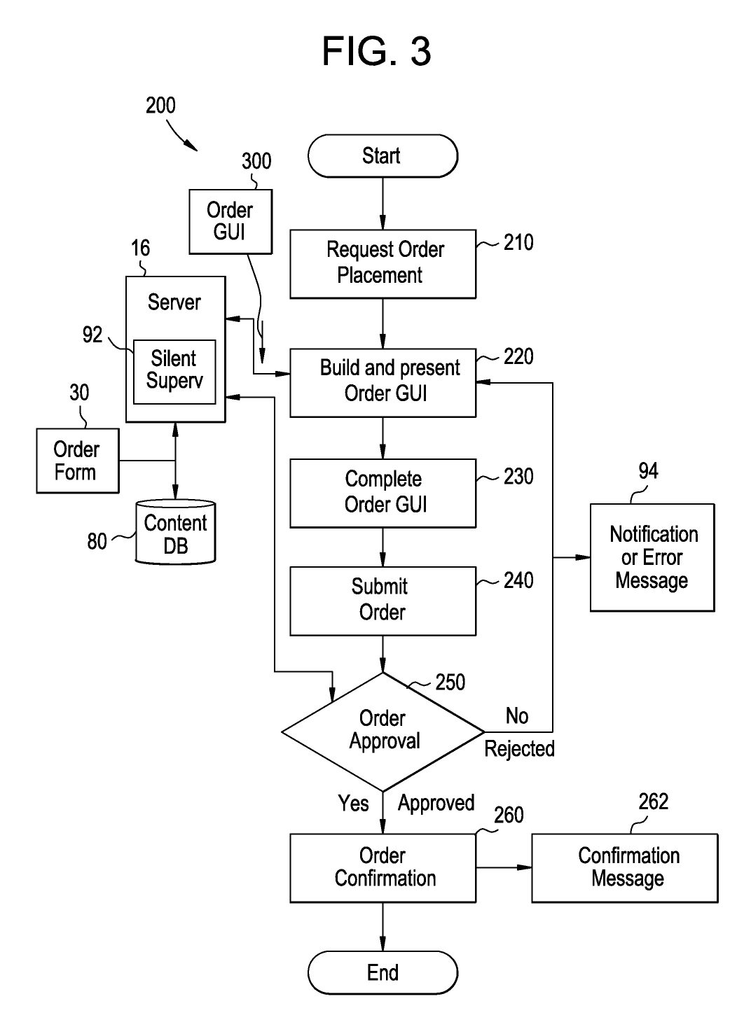

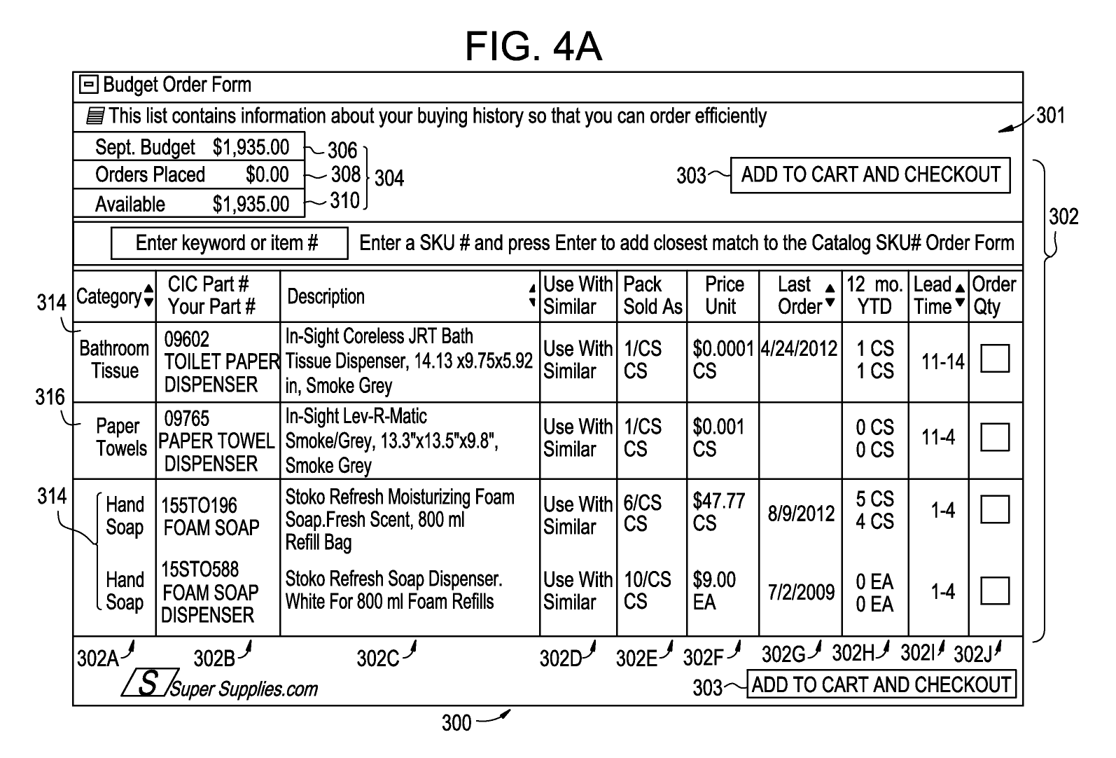

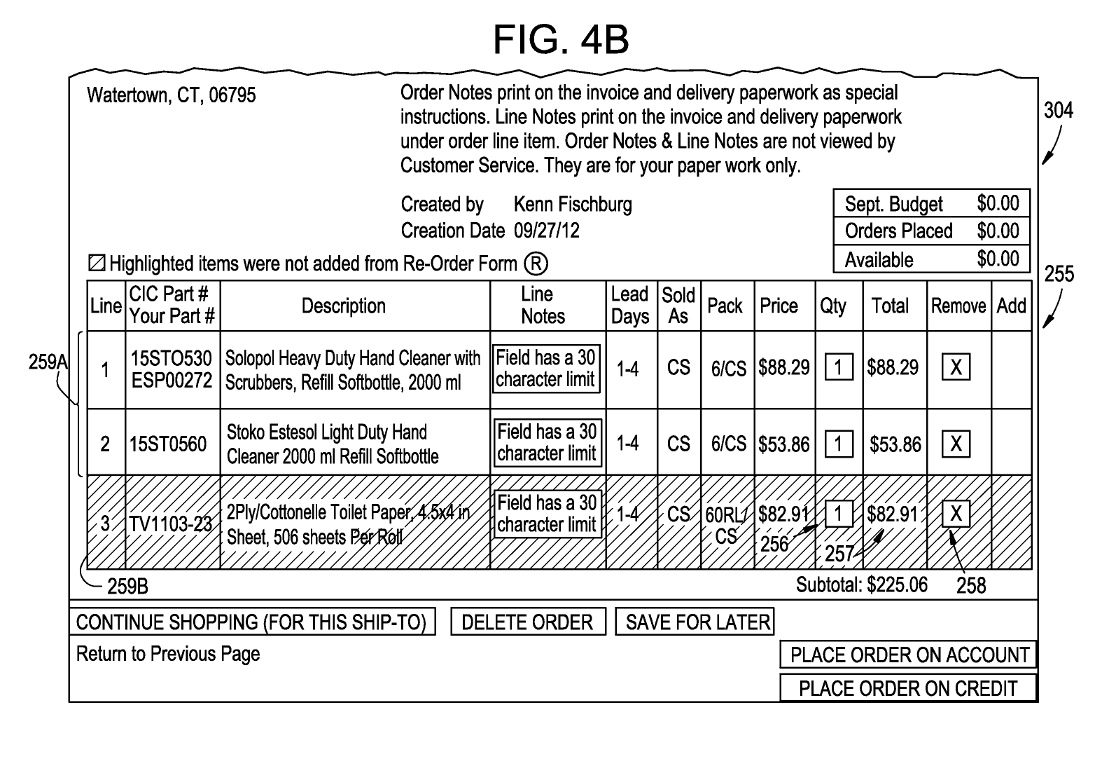

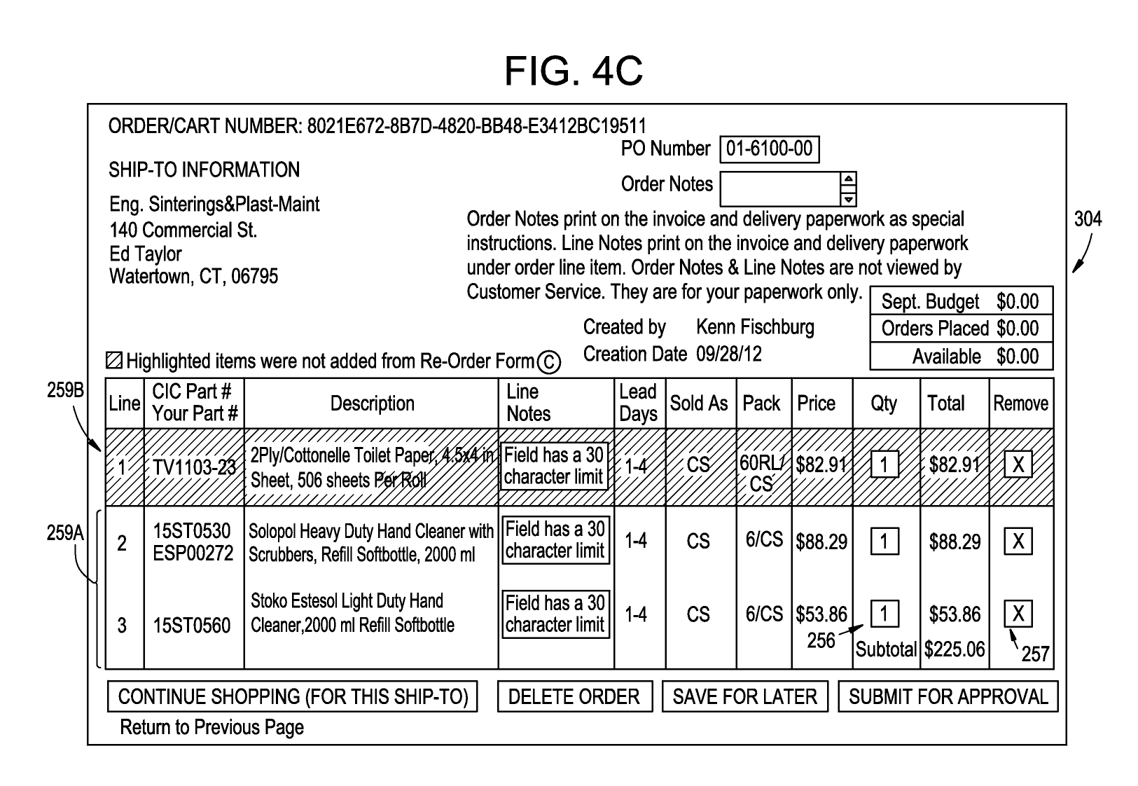

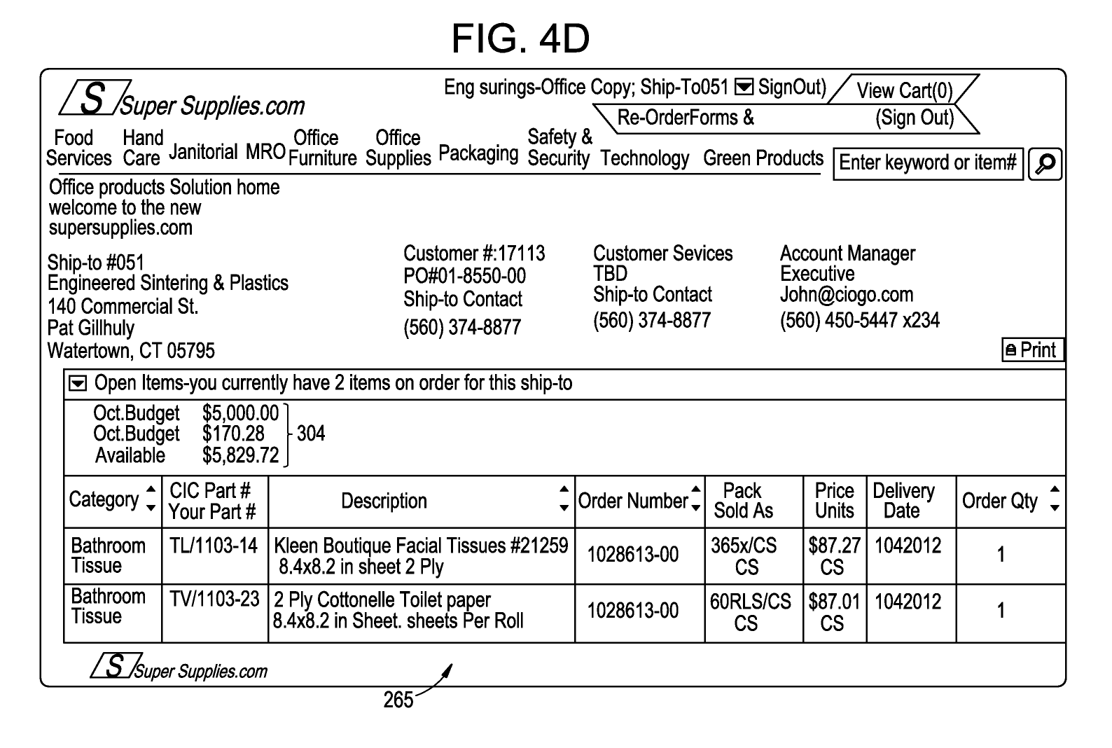

Referring now to FIGS. 3 and 4A, embodiments are shown of a procurement order entry procedure 200 and of a customizable and/or predetermined order entry and/or list of goods and/or services to be purchased GUI 300, hereinafter order entry/shopping list GUI 300, (e.g., one embodiment of the account/order entry GUI 34), utilized in the SuperSupplies procurement system 10. At Step 210, when the SuperSupplies procurement system 10 receives a request for placement of an order by the user (generated at Step 120 of FIG. 2), the server 16 retrieves the order entry GUI 34 and relevant data and information 82, 84 and 86 for exhibition thereon from the content database 80. In one embodiment, shown in FIG. 4A, the server 16 presents the order entry GUI 34 as the order entry/shopping list GUI 300. As noted above, the order entry/shopping list GUI 300 may be tailored to a user's needs and procurement habits based on information obtained in the above-described inventory, audit, query and tracking processes and retrieved from the content database 80. In one embodiment, goods and/or services as well as the budgetary spending thresholds, goals and/or constraints presented on the order entry/shopping list GUI 300 may be based upon past procurement activities of a user, group, department, company or groups thereof (e.g., goods/services purchased, increase, decrease, or maintenance of past procurement levels as defined by the user) or, for a new account or user, may be recommended by the administrator such that goods/services, quantities per order, budgetary spending thresholds, goals and/or constraints are initially established based upon industry standards or based upon “like” users, where industry standards and/or like or similar users are comparable in number of employees, trade channel, gross or net sales, and the like.

As shown in FIG. 3, when building the order entry/shopping list GUI 300 for presentation to the user at Step 220, the server 16 invokes software modules such as the Silent Supervisor module 92 to populate one or more fields 302 of the GUI 300. For example, the order entry/shopping list GUI 300 includes one or more fields 302 that are indicative of user defined data and information pertaining to the goods and/or services (e.g., data and information 82) and other information (e.g., data and information 84 and 86) shown thereon. The fields 302 may be accessed and updated by the user using an input device such as a key board or pointing device such as a mouse, light pen and the like, using drop-down menus, or by typing information into the fields 302. In one embodiment, the fields 302 include a user definable “product category” 302A, goods/service “part number” (e.g., supplier and/or user defined numbers) 302B, “description” 302C, “use with similar” item 302D, unit packaging “Pack Sold As” 302E, unit pricing and unit description information 302F, previous order data including “last order” date 302G (per goods/services and/or accumulations of groups thereof), budgetary spending data and information including usage information such as usage within the previous “12 months” and year to date usage (e.g., a “YTD” field) 302H, “lead time” for the item 302I, and a requested order quantity 302J, among other fields. The fields 302 on the order entry/shopping list GUI 300 can comprise permanent fields that always form part of the GUI 300, and user defined fields. These fields can be customized according to a user's preferences. For example, a user may want to track orders that pertain to a particular user, department, location or customer. In addition, the user may want to track orders or goods usage pertaining to a particular individual. To accomplish this, the user is given the option of entering the fields him/herself or requesting the maintainer of the database to enter the fields. These fields can be entered permanently, for a specified period of time, or for one time use. Alternately, information in the fields 302 may be set to default values. In one embodiment, the data and information 82 indicative of raw material, parts, supplies, and services available for display to and purchase by the users is populated and presented to the user in, for example, the table format within fields 302 of FIG. 4A. In one embodiment, line items 314 within the table represent previously purchased goods and/or services (e.g., line items with previous order data 302G, usage information 302H, etc.) as well as newly enter line items 316. In one embodiment, the SuperSupplies system 10 includes a re-order form function that populates line items based on the user's past procurement activities. For example, routinely purchased goods and/or services may be exhibited on the order entry/shopping list GUI 300 regularly, at predetermined time periods, and the like, as defined by the user and/or system administrator. In one embodiment, the goods and/or services within the re-order form function are predetermined “economically correct” items for the user.

In accordance with the present invention, the order entry/shopping list GUI 300 includes and, in one embodiment, prominently exhibits and/or highlights, budgetary spending thresholds, goals and/or constraints information 304. As shown in FIG. 4A, the budgetary spending thresholds, goals and/or constraints information 304 is determined by the Silent Supervisor module 92 and is exhibited, in one embodiment, in a table format at a visually prominent location on the order entry/shopping list GUI 300, e.g., at a header section 301 of the order entry/shopping list GUI 300. The budgetary spending thresholds, goals and/or constraints information 304 includes a budgetary spending set point 306 defining a period-specific spending limit (e.g., where the period is one of daily, weekly, monthly, quarterly, yearly, and the like), a tally or accumulation total 308 of current spending (e.g., based on real time or periodically updated information gathered by the SuperSupplies procurement system 10 and, in particular, by the Silent Supervisor module 92 monitoring and accumulating costs of goods and/or services procured), and an amount available for new procurement orders 310 determined by, for example, the Silent Supervisor module 92 applying the accumulation total 308 against the budgetary spending set point 306.

It should be appreciated that exhibiting the budgetary spending thresholds, goals and/or constraints information 304, as well as generating notification messaging as described herein, highlight and reinforce procurement needs of the user, including an established budgetary spending set point derived from the information and data 84 (e.g., establishing the budgetary spending set point 306) at one of a user level, a group of users level, a goods/service level, a group of goods/services level, a facility level, a group of facilities level, an organization level or a group of organizations level, accumulation of real time or periodically updated procurement (e.g., spending) data from purchases and/or orders at the defined level placed during a predetermined timeframe such as, for example, daily, weekly, monthly, quarterly, yearly, or the like (e.g., the accumulation total 308), as well as the resulting amount available for additional purchases and/or orders during the timeframe (e.g., the amount available 310).

At Step 230, the user completes the order entry/shopping list GUI 300 by filling in one or more of the fields 302, including a quantity to order field shown generally at 312, by entering or selecting, for example, a part number or SKU number into a predetermined field, or by clicking an add to cart button 303 to invoke the shopping cart GUI 37. Once completed, at Step 240, the user can review the “contents” of the shopping cart GUI 37 and can elect to place the order, with or without updates thereto (e.g., changes to quantities, removal of items previously selected from the cart, and the like). Placing the order can essentially be a “point-and-click” process in which data and information indicative of desired goods and/or services is entered into the content database 80 through the network 14. Once submitted, at Step 240, the order can be subject to supervisory review and approval in an approval step 250 where it may be approved, rejected or placed on hold within the user's company (e.g., an internal review) or by one or more suppliers that receive the order or a portion thereof (e.g., an external review). For example, the order may be rejected for any number of reasons, e.g., the user has exceeded a budgetary spending limit (e.g., an internal review and rejection), the user's company is in arrears (e.g., an external review and rejection), etc.

In one embodiment, the review and approval step 250 may include presenting one or more GUIs, based on user permissions, that present an order and the goods and/or services ordered as the line items to the reviewing and approving party. As shown in FIGS. 4B and 4C, the GUIs may include Approval GUIs 255A (FIG. 4B) and 255B (FIG. 4C) wherein the line items are presented and the reviewer may alter a quantity ordered at 256, remove an item from the order at 257 or add the items to the re-order form function, at 258. In one embodiment, “new” items (e.g., items that were not previously within the re-order form function) are visually identified to the reviewer such as, for example, by highlighting, bolding or otherwise identifying the line item (e.g., line items 259A versus items 259B, which are highlighted). As is illustrated by comparing FIGS. 4B and 4C, an ability to add new items to the re-order form function at 258, may not be available for all reviewers and may be password or otherwise limited to a subset of users/reviewers. It should be appreciated that, as noted above, items within the re-order form function are economically correct for the procurement needs of the user and, as such, only selected reviewers and users may add items to the re-order form function.

As noted above, review, rejections, suspensions and/or approvals can occur automatically due to budgetary spending thresholds, goals and/or constraints, as well as order and delivery dates, and the like. The criterion for automatic review, approval, denial and/or hold, are configurable via user defined fields. These user defined fields can be relevant to, inter alia, the quantity, cost or the like, of goods and/or services that can be ordered at any one time in any single transaction. Accordingly, one of the user defined fields could be a preset quantity budget field. The approval process can be by line items of an order, by user placing the order, or the like. In addition, password controls can be implemented so that only personnel having approval authority can exercise it. Therefore, authorized personnel can receive an e-mail message that an order is waiting for approval. A link can be “clicked” such that the person can log in using the password and access the order information for review, approval, suspension or denial. If rejected, the user is directed back to a previous step such as the build and present order GUI step 220, e.g., by following the “no, rejected” path from Step 250 to Step 220. If the order is approved, a confirmation step 260 is executed in which a confirmation message 262 with the pertinent details is displayed or otherwise provided to the user, his/her supervisor or like person of interest. The confirmation message 262 may also display a confirmation number or other data. The confirmation messages 262 and/or other data or information may also be forwarded (e.g., via e-mail or the like) to others associated with the order (salesman, accounting, shipping/receiving, etc.) Once confirmed, the procurement order entry procedure 200 is completed.

It should be appreciated that not every line item in a given order may be immediately available for shipment by a vendor. In the industry, it is known for such unavailable items to be “back ordered.” As shown in FIG. 4D, an Open Items GUI 265 exhibits goods and/or services (e.g., order line items 314, 316) that were ordered, approved but unavailable. In one embodiment, these unavailable items contribute to the procurement accumulations (e.g., item quantities and costs) that are being monitored by the Silent Supervisor 92. For example, the budgetary spending thresholds, goals and/or constraints information 304 exhibited throughout the SuperSupplies system 10 accounts for these items. As such, a subsequent order for these unavailable items would be avoided.

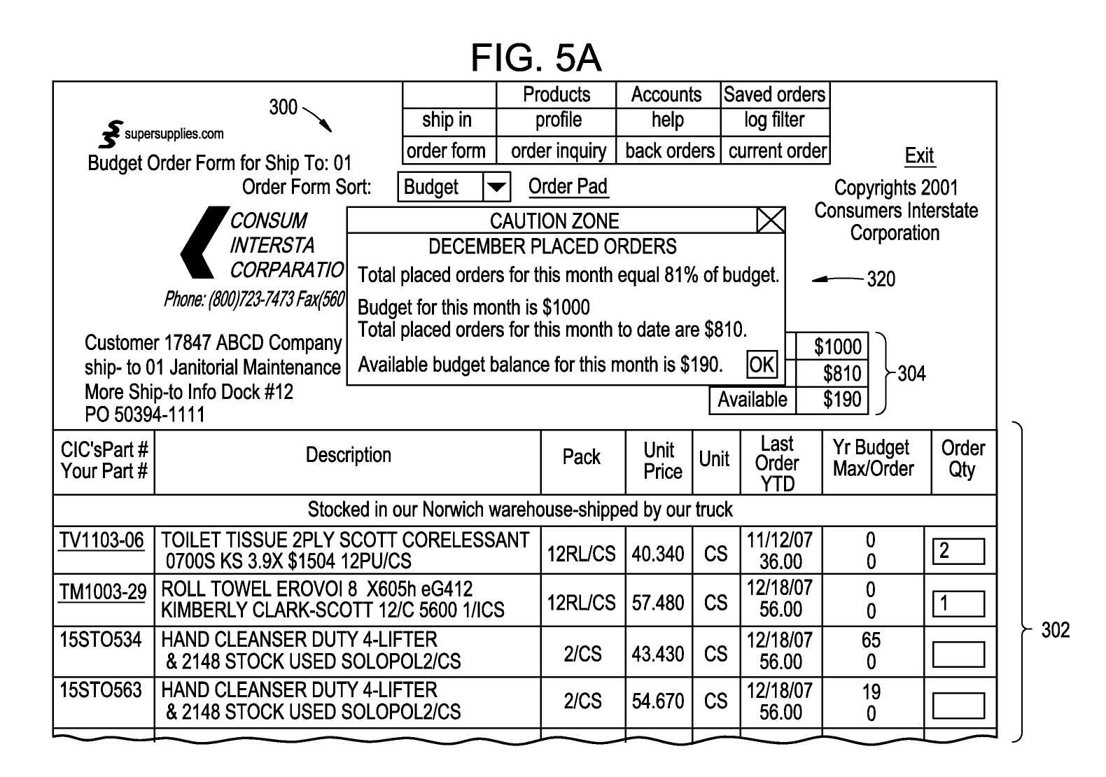

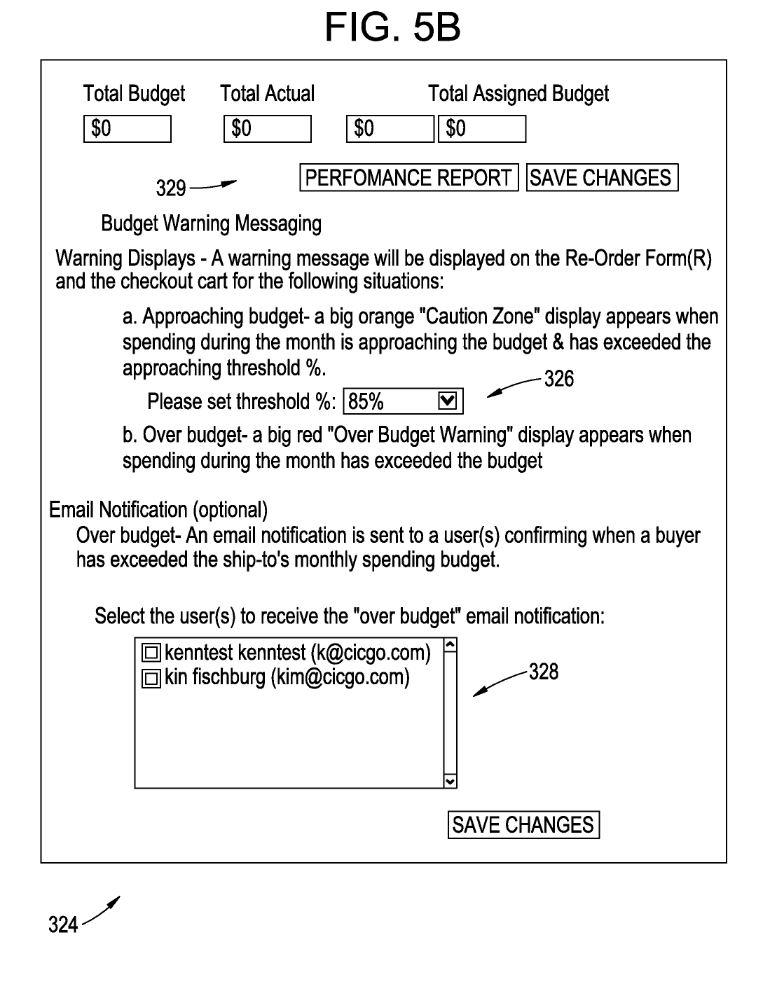

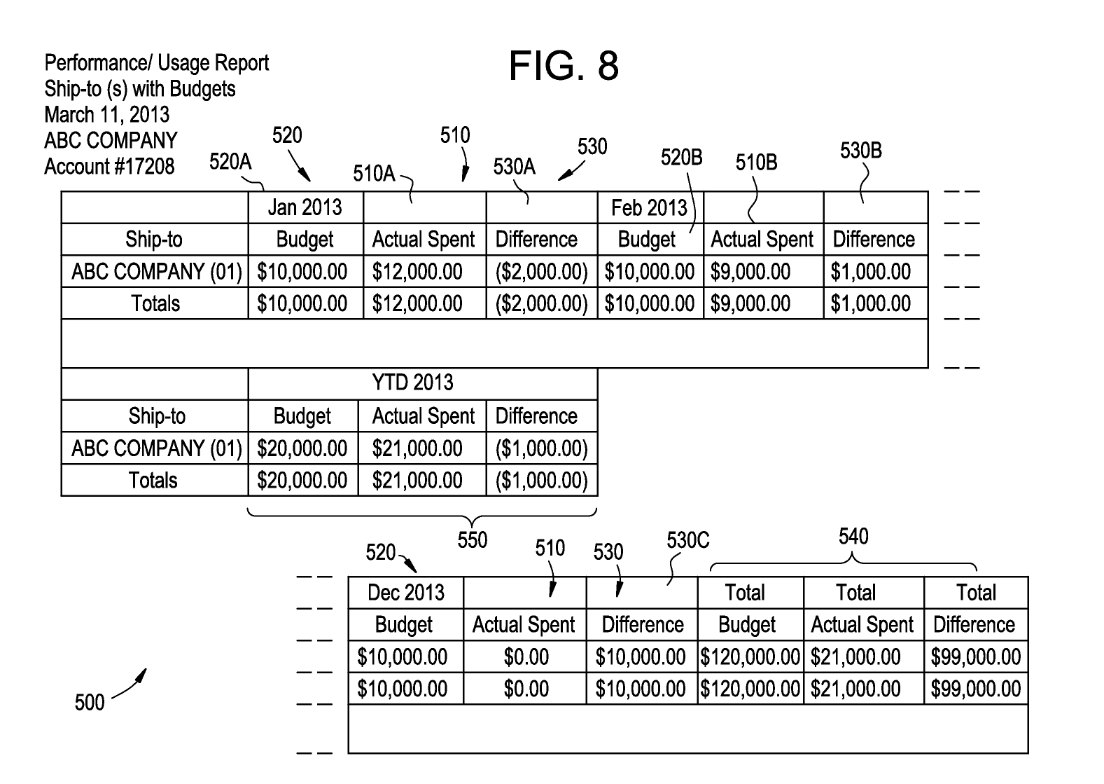

In one embodiment, illustrated in FIG. 3, in one or both of the build and present order GUI Step 220 and the approval Step 250, the server 16 and the Silent Supervisor module 92 are invoked to monitor in real time or at scheduled intervals the costs of requested goods and/or services on the order entry/shopping list GUI 300 and the accumulated costs of goods and/or services ordered at the defined level during the defined timeframe in previous transactions. When the predetermined budgetary spending thresholds, goals and/or constraints are at least one of approached, met or surpassed, notification messages 94 are generated by the Silent Supervisor module 92. For example, as shown in FIG. 5A that illustrates a portion of the order entry/shopping list GUI 300, the Silent Supervisor module 92 presents a message 320 to the user notifying the user that one of the predetermined budgetary spending thresholds, goals and/or constraints is being approached (e.g., a “Caution Zone” message 320 indicating that 81% of the budgetary spending set point 306 has been reached). As shown in FIG. 5B, a Budget Warning Message GUI 324 permits the user and/or system administrator an ability to assign a threshold 326, for example, a threshold percentage, at which one or more notifications are generated by the Silent supervisor module 92 and sent to one or more users defined at 328. In one embodiment, performance reports may be requested, at 329, and generated to provide visibility to the user's performance to budget at one of a user level, a group of users level, a goods/service level, a group of goods/services level, a facility level, a group of facilities level, an organization level or a group of organizations level. The performance reports may be made available to users at one or more output devices, e.g., user output devices 58 at FIG. 1 on-line as a GUI, in paper format, or the like, as a report format or in a spreadsheet program format. One exemplary Performance/Usage Report format 500 is illustrated in FIG. 8, where values of actual dollars spent 510 during a period, e.g., a month of a year, such as January 2013 at Actual Spent 510A, February 2103 at Actual Spent 510B and the like, are presented with budget values 520 for the period, e.g., January 2013 Budget at 520A, February 2013 Budget 520B, and difference values 530 indicating performance to the budget and calculated by, for example, subtracting the Actual Spent 510 value from the Budget 520 value, e.g., January 2013 Difference at 530A, February 2013 Difference 530B. As shown in FIG. 8, performance may be monitored at a total period, e.g., yearly totals at 540, and at a period to date, e.g., YTD 2013 at 550. As shown in FIG. 8, one or more periods may show a negative difference (530A), a positive difference (530B) or no difference (530C) between the actual and budgeted values. The relative difference in values for a given period, group of periods or portions thereof, being at least one indicator of performance.

As noted above, the Silent Supervisor module 92 implements a multi-level and/or multi-tiered notification system to alert one or more users of or other persons of interest within the SuperSupplies system 10 that one or more of the predetermined budgetary spending thresholds, goals and/or constraints is approaching, has been met or has been surpassed. While shown in FIG. 5 as a pop-up message or banner 320, it should be appreciated that the notification messages 94 that are generated by the Silent Supervisor module 92 include, for example, visual, audio or written notifications provided as a message on one or more of the GUIs 30 (e.g., a colored and/or blinking icon, a banner message, a broadcast message, an audio tone or alert message, or the like provided to or on display device of a computing device operated by the user), a message sent per a user's contact information (e.g., an email or text message sent to a predetermined address of the user), and the like. In one embodiment, the system generated notification messages 94, 320 may vary in color, size, intensity, duration or the like, as accumulations vary in proximity to the one or more predetermined budgetary spending thresholds, goals or constraints. For example, when a selected cost accumulation data value approaches a first of the one or more predetermined budgetary spending thresholds, goals and/or constraints, the notification is generated and appears in a first colored font (e.g., the notification appears in a yellow font color), when the selected cost accumulation data value continues to grow and meets a second one of the one or more predetermined budgetary spending thresholds, goals and/or constraints, the notification changes from the first colored font to a second colored font or appears as a blinking font (e.g., the notification changes from the yellow colored font to an orange colored font), and when the selected cost accumulation data value exceeds or surpasses the predetermined budgetary spending thresholds, goals and/or constraints, the notification appears as a third colored font or appears as a rapidly blinking font (e.g., the notification changes from the orange font color to a red font color). It should be appreciated that it is within the scope of the present invention for the system generated notifications and changes thereto to be considered broadly. As such, some exemplary system generated notifications formats and styles are described in further details below, but those skilled in the art appreciate that the notifications (e.g., notification messages 94, 320) may take any number of formats, styles and the like as are known or would be considered convenient to convey a change in status to users of the systems and methods described herein.

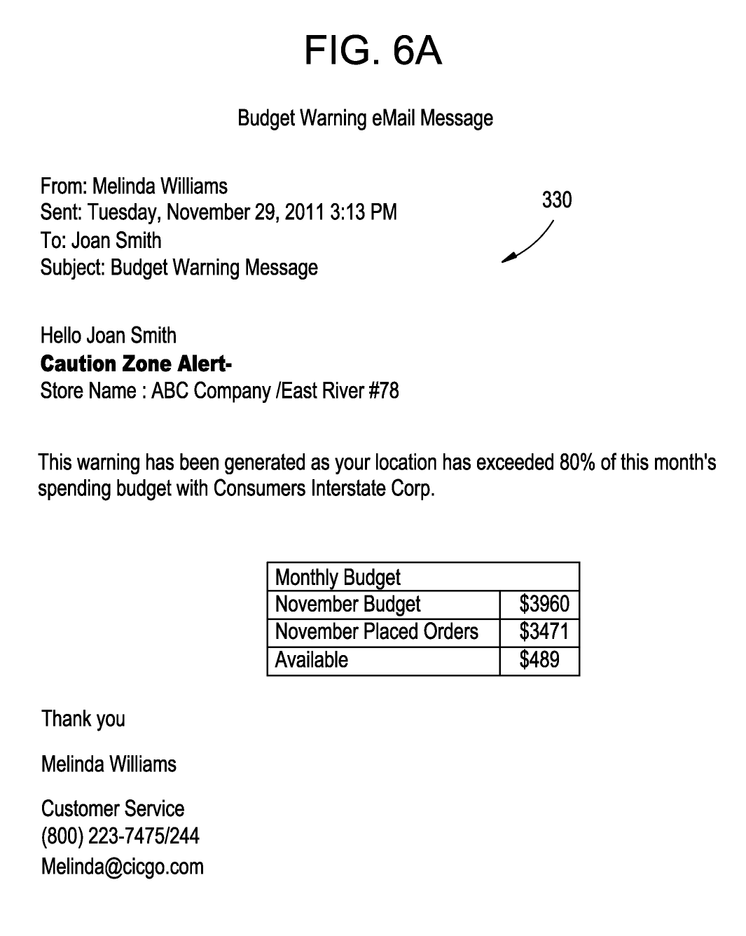

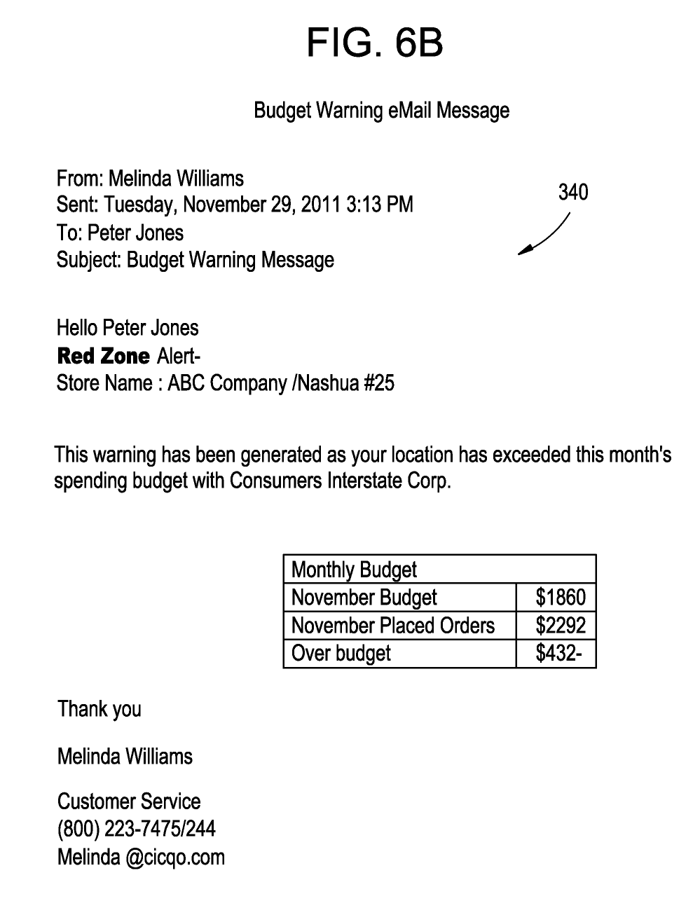

In one embodiment, illustrated in FIGS. 6A and 6B, the Silent Supervisor module 92 generates one or more electronic messages 330 and 340, e.g., an electronic mail (email) message, to one or more of the users (e.g., Joan Smith and Peter Jones) notifying the users that one of the predetermined budgetary spending thresholds, goals and/or constraints is being approached, e.g., a Caution Zone Alert message 330 sent to Joan Smith that a predetermined threshold, goal and/or constraint (e.g., a November Monthly spending threshold) is approaching (e.g., spending has exceeded eighty percent (80%) of approved November spending) as shown in FIG. 6A, or that one of the predetermined budgetary spending thresholds, goals and/or constraints has been exceeded, e.g., a Red Zone Alert message 340 sent to Peter Jones that the predetermined threshold, goal and/or constraint (e.g., the November Monthly spending threshold) has been exceeded as shown in FIG. 6B.

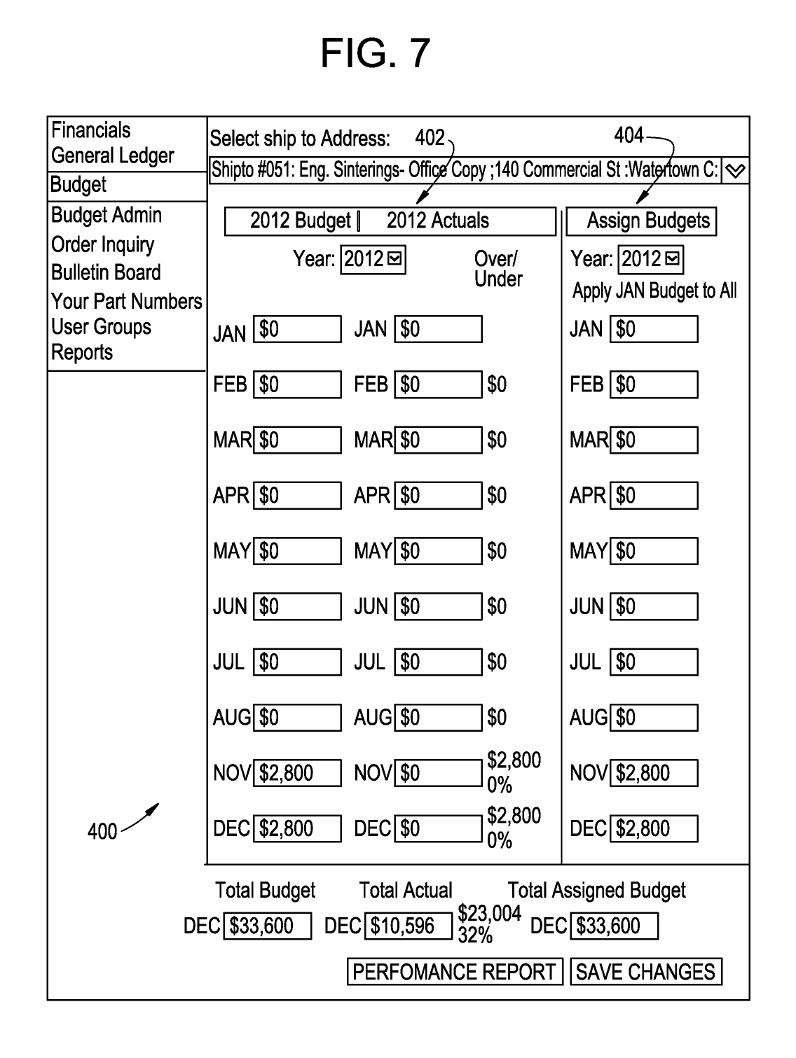

As described herein the SuperSupplies procurement system 10 including the budgetary notification function and the automatic review and approval, denial or hold function deployed as the Silent Supervisor module 92 monitors procurement in real time and/or at scheduled intervals to generate and send notification messages as budgetary spending thresholds, goals and/or constraints are at least one of approached, met or have been exceeded. Some perceived advantages of the SuperSupplies procurement system 10 include an ability to monitor and target, for example, cost containment and reduction, inventory control and reduction, and other procurement improvements at one of a user level, a group of users level, a goods/service level, a group of goods/services level, a facility level, a group of facilities level, an organization level or a group of organizations level, over a predetermined timeframe such as, for example, daily, weekly, monthly, quarterly, yearly, or the like. In one embodiment, the budgetary spending thresholds, goals and/or constraints may be based on a previous term such as last year's spending. As described herein, the budgetary spending thresholds, goals and/or constraints may be periodically updated (e.g., adjusted higher, lower or the like) by the user. For example, FIG. 7 illustrates an exemplary embodiment of an interface 400 for assigning and/or updating values to the budgetary spending thresholds, goals and/or constraints including, for example, the budgetary spending set point 306 as a monthly budget, referred to herein as a Budget Management interface 400. As shown in FIG. 7, the Budget Management interface 400 may include budgetary and/or actual spending thresholds, goals and/or constraints 402 for a current or previous time period (e.g., a month-by-month breakdown for a year 2012 is illustrated) as well as fields for assigning a current time period 404 (e.g., corresponding months for year 2012) or a next time period such as year 2013.

In one embodiment, a “bulletin board” message may be implemented in the SuperSupplies procurement system 10, for example, as a heading message on one or more of the GUIs 30 or 300 of the web site 28, advising users to “stop spending” or the like, when one or more budgetary spending thresholds, goals and/or constraints is met or surpassed.

Additional benefits of the SuperSupplies procurement system 10 include making users (e.g., buyers) aware of current spending and spending limits over one or more time periods; making budgetary spending thresholds, goals and/or constraints visible to all users; achieving and instituting discipline in procurement practices; automating spending controls to reduce or at least regulate spending to desired levels; implementing cost containment and reduction, inventory control and reduction, and other procurement improvements, each at one of a user level, a group of users level, a goods/service level, a group of goods/services level, a facility level, a group of facilities level, an organization level or a group of organizations level, over a predetermined timeframe such as, for example, daily, weekly, monthly, quarterly, yearly, or the like.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above-detailed description, but that the invention will include all embodiments falling within the scope of the appended claims.

What is claimed is:

1. A method for procuring goods and/or services executable on a processor based system, the method comprising:
providing a processor having a memory with an executable program stored therein;
determining a specific procurement process of a user and data related thereto, the process data including one or more budgetary spending thresholds, goals and/or constraints for procurement of the goods and/or services;
hosting, by the processor, a website operative with the program and a content database;
receiving the data indicative of the user's procurement process for the goods and/or services and storing the received data in the content database;
determining a value representing a budgetary spending set point based on the one or more budgetary spending thresholds, goals and/or constraints;
presenting, at the website, a plurality of graphical user interfaces (GUIs) using the program and the data stored in the content database, the plurality of GUIs including fields for selecting the goods and/or services to create one or more orders;
processing the one or more orders within the user's procurement transactions by:
accumulating procurement data from the one or more orders, the procurement data including a cost associated with the goods and/or services within the order transactions;
comparing the value representing the budgetary spending set point to a value representing the cost within the accumulated procurement data; and
when the value representing the cost within the accumulated procurement data at least one of approaches, meets and surpasses the value representing the budgetary spending set point, generating at least one notification message; and
after the order is processed, shipping the goods and/or providing the services to the user.

2. The method of claim 1 wherein the determining step includes inventorying a facility of the user, auditing the user's procurement records, and querying the user's personnel involved with the procurement process and collecting the data related thereto.

3. The method of claim 1 wherein the budgetary spending thresholds, goals and/or constraints are determined for a period at one of a user level, a group of users level, a goods/service level, a group of goods/services level, a facility level, a group of facilities level, or an organization level or group of organizations level.

4. The method of claim 3, wherein the period is comprised of a period of time including hourly, daily, weekly, monthly, quarterly, yearly, or a portion thereof.

5. The method of claim 1, wherein the value representing the budgetary spending set point is determined by the user for a period at one of a user level, a group of users level, a goods/service level, a group of goods/services level, a facility level, a group of facilities level, or an organization level or group of organizations level.

6. The method of claim 5, wherein the steps of processing the one or more orders include accumulating the procurement data, comparing the value representing the budgetary spending set point to the value representing the cost within the accumulated procurement data and generating the notification message are performed at the user defined level.

7. The method of claim 1, wherein the stored data indicative of the user's procurement process for the goods and/or services defines a procurement knowledge base for the user, the method further including continually updating the procurement knowledge base for the user with the accumulated procurement data for the user.

8. The method of claim 7, further including updating the value representing the budgetary spending set point based on the updated procurement knowledge base.

9. The method of claim 1, further including:
monitoring performance of the user relative to the one or more budgetary spending thresholds, goals and/or constraints.

10. The method of claim 9, further including updating the value representing the budgetary spending set point based on the monitored performance of the user relative to the one or more budgetary spending thresholds, goals and/or constraints.

11. The method of claim 1, wherein the notification message includes one of a visual, audio or written notification message.

12. The method of claim 11, wherein the notification message includes one of a message on at least one of the plurality of GUIs, and at least one message sent per at least one user's contact information.

13. The method of claim 12, wherein the user defines one or more persons of interest to receive the generated notification message.

14. The method of claim 1, wherein the order is processed and the notification message is generated at one of a point of entering the order on one of the plurality of GUIs, and at a scheduled interval after the order is entered on one of the plurality of GUIs.

15. The method of claim 1, wherein the accumulating step includes:
accumulating a value representing a quantity of the goods and/or services within the order transactions.

16. The method of claim 1, wherein the step of presenting includes:
exhibiting on the plurality of GUIs the value representing the budgetary spending set point, the value representing the cost within the accumulated procurement data, and a value representing cost available for additional order transactions.

17. The method of claim 16, wherein the value representing cost available for additional order transactions is derived by subtracting the value representing the cost within the accumulated procurement data from the value representing the budgetary spending set point.

18. The method of claim 1, wherein the generated notification message varies in at least one of color, size, intensity, and duration as the value representing the cost within the accumulated procurement data approaches, meets and surpasses the value representing the budgetary spending set point.

19. The method of claim 1, further including:
processing the one or more orders at a point of order entry; and
automatically determining a status of the order based on the comparison of the value representing the cost within the accumulated procurement data and the value representing the budgetary spending set point

20. The method of claim 19, wherein the status of the order includes at least one of approving the order, denying the order, and placing the order on hold.

21. The method of claim 20, wherein the status of the order is at least one of denied and placed on hold when at least one of the cost of the order exceeds a predetermined spending limit, would result in an accumulated cost that is within a predetermined percentage from the budgetary spending set point, is placed after a predetermined date, and would result in delivery of goods and/or services after a predetermined date.

22. The method of claim 20, wherein the status of the order is approved when the cost of the order is less than a predetermined minimum cost.

23. The method of claim 20, wherein the status of the order is approved when a quantity of goods and/or services within the order is less than a predetermined minimum quantity.

24. The method of claim 1, wherein the step of presenting the plurality of GUIs including the fields further includes:
exhibiting fields based on the data pertaining to the goods and/or services as line items derived from the user's past procurement activities.

25. The method of claim 24, wherein the line items include data of goods and/or services previously selected by the user to be economically correct for the user.
